(19) United States
(12) Patent Application Publication
(10) Pub. No.: US 2006/0219037 A1
(43) Pub. Date: Oct. 5, 2006

(54) Support structure and gear mechanism having the same

(75) Inventors: Hideyuki Inose, Tochigi (JP); Kenji Fukasawa, Tochigi (JP)

Correspondence Address: MORRISON & FOERSTER, LLP, 555 WEST FIFTH STREET, SUITE 3500, LOS ANGELES, CA, 90013-1024, US

(73) Assignee: Tochigi Fuji Sangyo Kabushiki Kaisha, Tochigi-Shi (JP)

(21) Appl. No.: 10/552,387

(22) PCT Filed: Apr. 16, 2004
(86) PCT No.: PCT/JP04/05470

§ 371 Date: Oct. 7, 2005

(30) Foreign Application Priority Data
Apr. 16, 2003 (JP) 2003-111727

(51) Int. Cl. F16H 48/20

(52) U.S. Cl. 74/424

(57) ABSTRACT

A gear mechanism is provided with a change-direction gear set to change a rotation direction of a driving force at a right angle, the change-direction gear set comprising a first change-direction gear and a second change-direction gear; an input shaft rotating coaxially and integrally with the second change-direction gear; an output shaft disposed in parallel with the input shaft; a power transmission device coupling the input shaft with the output shaft; a housing member housing the input shaft, the output shaft and the power transmission device; a pair of first bearings aligned in an axial direction, the first bearings rotatably supporting the input shaft with respect to the housing member; a pair of second bearings aligned in an axial direction, the second bearings rotatably supporting the output shaft with respect to the housing member; and a pair of third bearings rotatably supporting the first change-direction gear with respect to the housing member. The power transmission device is disposed between the pair of the first bearings, and at least any one pair of the first bearings and the second bearings are disposed in the vicinity of the second change-direction gear.

### TECHNICAL FIELD

The present invention relates to a support structure having a compact constitution, mainly applied to a transfer case of a four-wheel-drive vehicle, and a gear mechanism having the same.

### BACKGROUND ART

A four-wheel-drive vehicle is in general provided with a transfer case for transmitting driving force of an engine to both front and rear axles. A transfer case in accordance with one of proposed arts is coupled with any axles of front and rear axles, which receive the driving force of the engine via a transmission and a differential case. The transfer case is configured to convert a direction of the driving force by means of a pair of bevel gears and partly transmit the driving force via a shaft to the opposite axles.

Moreover, in accordance with another art, a transfer case is directly coupled with an output shaft of a transmission and configured to distribute the driving force to shafts respectively coupled with front and rear axles by means of a differential and a chain transmission mechanism.

### DISCLOSURE OF INVENTION

The bevel gears have complex constitution and tend to be large-sized because the bevel gears need to be further provided with unitized thrust bearings for receiving thrust loads, regulation devices for regulating engagement positions between the gears and other such mechanisms. Moreover the chain transmission mechanism and the differential make a constitution further complex. The present invention is intended for providing a transfer case having a compact constitution.

According to a first aspect of the present invention, a support structure is provided with: an input shaft and an output shaft for input and output of driving force; a power transmission device coupling the input shaft with the output shaft; a housing member housing the input shaft, the output shaft and the power transmission device; a pair of first bearings aligned in an axial direction, the first bearings rotatably supporting the input shaft with respect to the housing member; and a pair of second bearings aligned in an axial direction, the second bearings rotatably supporting the output shaft with respect to the housing member, wherein the power transmission device is disposed between the pair of the first bearings, and at least any one pair of the first bearings and the second bearings are disposed in the vicinity of an input/output device for input/output the driving force to the input shaft and the output shaft.

According to a second aspect of the present invention, a gear mechanism is provided with: a change-direction gear set to change a rotation direction of a driving force at a right angle, the change-direction gear set comprising a first change-direction gear and a second change-direction gear; an input shaft rotating coaxially and integrally with the second change-direction gear; an output shaft disposed in parallel with the input shaft; a power transmission device coupling the input shaft with the output shaft; a housing member housing the input shaft, the output shaft and the power transmission device; a pair of first bearings aligned in an axial direction, the first bearings rotatably supporting the input shaft with respect to the housing member; a pair of second bearings aligned in an axial direction, the second bearings rotatably supporting the output shaft with respect to the housing member; and a pair of third bearings rotatably supporting the first change-direction gear with respect to the housing member, wherein the power transmission device is disposed between the pair of the first bearings, and at least any one pair of the first bearings and the second bearings are disposed in the vicinity of the second change-direction gear.

According to a third aspect of the present invention, a gear mechanism is provided with: a change-direction gear set to change a rotation direction of a driving force at a right angle, the change-direction gear set comprising a first change-direction gear and a second change-direction gear; a first gear rotating coaxially and integrally with the second change-direction gear; a second gear disposed in parallel with and engaged with the first gear; a third gear disposed in parallel with and engaged with the second gear; and a casing housing the change-direction gear set, the first gear, the second gear and the third gear.

### BRIEF DESCRIPTION OF DRAWINGS

FIG. 1 is a transfer case according to a first embodiment of the present invention;

FIG. 2 is a transfer case according to a second embodiment of the present invention;

FIG. 3 is a transfer case according to a third embodiment of the present invention;

FIG. 4 is a fragmentary view taken in the direction of the arrows substantially along the line IV of FIG. 3;

FIG. 5 is a fragmentary view taken in the direction of the arrows substantially along the line V of FIG. 3;

FIG. 6 is a fragmentary view taken in the direction of the arrows substantially along the line VI of FIG. 3;

FIG. 7 is a fragmentary view taken in the direction of the arrows substantially along the line VII of FIG. 3;

FIG. 8 is an example of a rear-engine four-wheel-drive vehicle to which a transfer case in accordance with any embodiment of the present invention; and

FIG. 9 is an example of a front-engine four-wheel-drive vehicle to which a transfer case in accordance with any embodiment of the present invention.

### BEST MODE FOR CARRYING OUT THE INVENTION

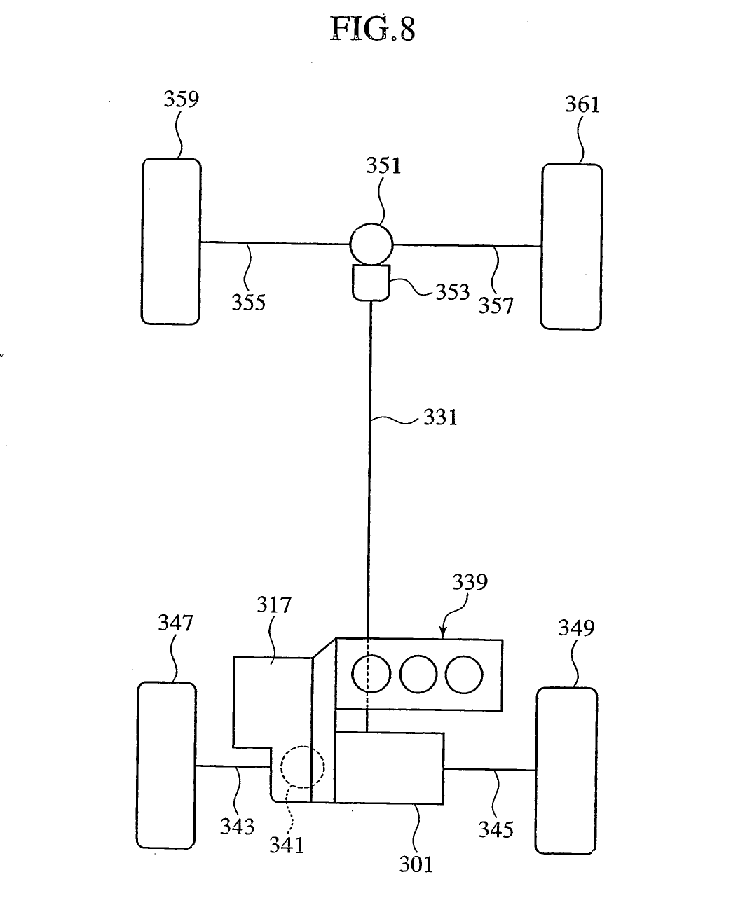

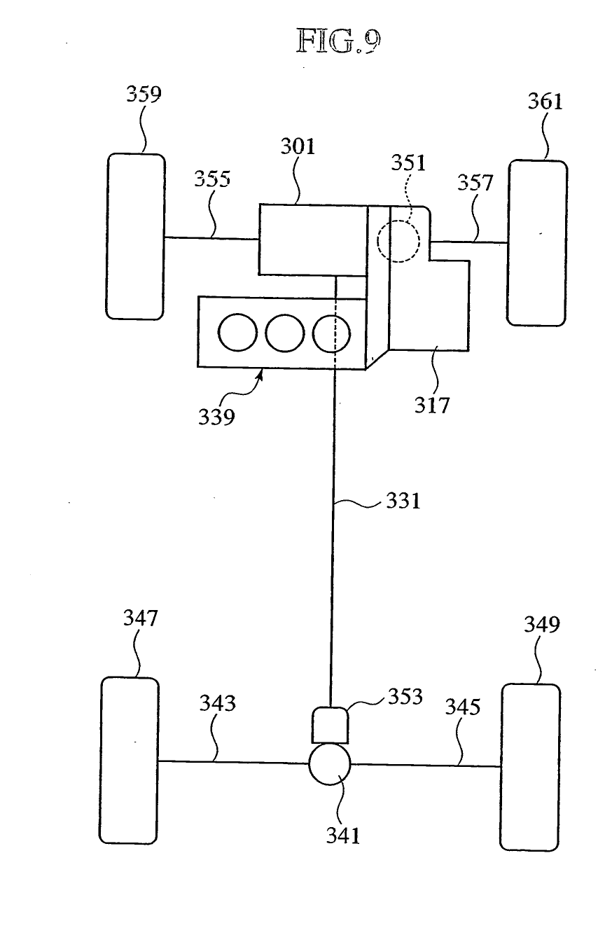

A four-wheel-drive vehicle, to which a transfer case in accordance with any embodiment of the present invention is applied, is provided with an engine 339, a transmission 317, a rear differential 341, a front differential 351, a transfer case 301 and a propeller shaft 331, as shown in FIG. 8 or FIG. 9. Driving force generated by the engine 339 is transmitted to an output gear of the transmission 317, further transmitted to the rear differential 341 via a ring gear engaging with the output gear in a case of FIG. 8, and then distributed to left and right rear axles 343 and 345. In a case of FIG. 9, the driving force is transmitted to the front-differential 351 and distributed to left and right front axles 355 and 357. The transfer case 301 is coupled with a casing of the rear differential 341 (in the case of FIG. 9, the front differential 351) and transmits the driving force in part to the propeller shaft 331.

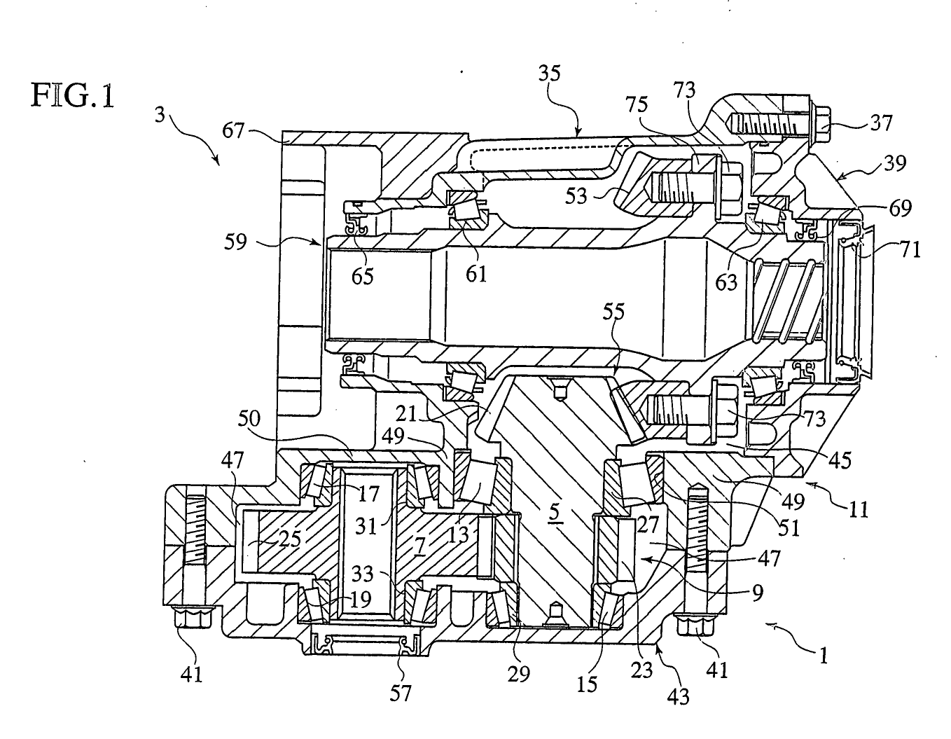

The transfer case to be described hereinafter is applied to a part shown as the transfer case 301 in FIG. 8 or FIG. 9. In the following description and FIGS. 1 through 3, front, rear, left and right directions are correspondent with the front, rear, left and right directions of FIG. 8 or FIG. 9, namely of the vehicle.

### FIRST EMBODIMENT

A first embodiment of the present invention will be described hereinafter with reference to FIG. 1. FIG. 1 and the following description will illustrate an example in which a transfer case 3 is coupled with front axles as shown in FIG. 9, however, it can be applied to a case where the transfer case 3 is coupled to rear axles as shown in FIG. 8 by properly changing directions of constitutional elements thereof.

The transfer case 3 is provided with a hollow shaft 59 to be coupled with the casing of the rear differential 341, a bevel gear 53 integrally rotating with the hollow shaft 59, a support structure 1 having a transfer gear set and a casing 11 (a housing member) for housing these elements.

The casing 11 is composed of a casing main body 35, a right cover 39 fixed with the casing main body 35 by means of bolts 37, a rear cover 43 fixed with the casing main body 35 by means of bolts 41. A housing chamber 45 (a first housing member) is formed between the casing main body 35 and the right cover 39; and a housing chamber 47 (a second housing member) is formed between the casing main body 35 and the rear cover 43. The housing chamber 45 and the housing chamber 47 are partitioned by a wall portion 49 having an opening 51 linking them. The wall portion 49 is provided with an extending wall portion 50 extending leftward in FIG. 1.

The hollow shaft 59 is rotatably supported by the casing main body 35 by means of a thrust bearing 61 at a left end thereof and rotatably supported by the right cover 39 by means of a thrust bearing 63 at a right end thereof. A seal 65 is interposed between the hollow shaft 59 and the casing main body 35 so as to prevent transmission oil in a transmission case 67 and transfer oil in the transfer case 3 from mixing with each other. Further, a seal 69 is interposed between the hollow shaft 59 and the right cover 39. A right rear axle 345 linking the front differential with the right front wheel penetrates the hollow shaft 59 and a seal 71 is disposed between the drive shaft and the right cover 39. Leakage of oil and intrusion of alien substances from the exterior are prevented by the seal 69 and 71.

The bevel gear 53 is fixed with a flange 75 of the hollow shaft 59 by means of bolts 73 so as to integrally rotate therewith. The bevel gear 53 engages with a bevel gear 21 to transmit driving force to a shaft 5 as described later.

The support structure 1 is disposed in a longitudinal direction correspondent to a direction where the vehicle moves and provided with a shaft 5 (an input shaft) to which driving force of an engine is input, a hollow shaft 7 (an output shaft) from which the driving force is output, a reduction gear set 9 (a power transmission device) linking the shaft 5 with the shaft 7, a pair of tapered roller bearings 17 and 19 (bearings) axially disposed and rotatably supporting the shaft 5 in thrust directions and radial directions with respect to the casing main body 35 of the casing 11 and the rear cover 43, and a bevel gear 21 (an input/output device) formed in a unitary body with the shaft 5 at a rear portion thereof.

One of gears of the reduction gear set 9 is disposed between a pair of tapered roller bearings 13 and 15, which rotatably support the shaft 5 in thrust directions and radial directions with respect to the casing main body 35 of the casing 11 and the right cover 39; and another is disposed between the bearings 17 and 19 of the shaft 7. The bearing 13 of the shaft 5 is provided in the vicinity of the bevel gear 21 on the shaft 5. The shaft 5 is disposed to penetrate the opening 51 of the wall portion 49 of the casing main body 35 and then span the housing chamber 45 and the housing chamber 47.

Moreover, the reduction gear set 9 is provided with a helical gear 23 having a relatively small diameter, which is splined to link with the shaft 5, and a helical gear 25 having a relatively large diameter, which is formed in a unitary body with the shaft 7. When the reduction gear set 9 is installed therein, the helical gear 23 abuts inner races 27 and 29 (shaft side members) of the bearings 13 and 15, which support the shaft 5, to give pressure to the bearings 13 and 15 and thereby center the shaft 5. Moreover, the helical gear 27 abuts inner races 31 and 33 (shaft side members) of the bearings 17 and 19, which rotatably support the shaft 7, to give pressure to the bearings 17 and 19 and thereby center the shaft 7.

The bevel gear 21 and the bevel gear 53 integrally rotating with the hollow shaft 7 are engaged with each other so as to compose a change-direction gear set 55 (a change-direction transmission device). Because the bevel gear 53 is larger in diameter than the bevel gear 21, the change-direction gear set 55 further has a speed-up function.

The shaft 5 is longitudinally housed in the housing chamber 47; rotatably supported by the casing main body 35 by means of the bearing 13; and further rotatably supported by the rear cover 43 by means of the bearing 19. Moreover, a hollow shaft 7 is splined to link with a link shaft and a seal 57 is disposed between the link shaft and the rear cover 43 so that leakage of oil and intrusion of alien substances from the exterior are prevented. The link shaft is coupled with the propeller shaft via a coupling and further coupled with the rear differential.

As being understood from the above description, the transfer case 3 transmits the driving force of the engine, which is transmitted to the differential casing of the front differential, to the change-direction gear set 55 from the differential casing via the hollow shaft 59 and the bevel gear 53. The change-direction gear set 55 changes the direction of the transmitted driving force while increasing the speed thereof and transmits the driving force to the support structure 1 via the bevel gear 21. The driving force transmitted to the support structure 1 makes the shaft 5 rotate and the rotation of the shaft 5 is reduced in speed by the reduction gear set 9 and transmitted to the shaft 7. Thereby, as mentioned above, the rotation is transmitted to the rear differential via the link shaft, the coupling and the propeller shaft.

In accordance with the present embodiment of the present invention, because the shaft 5 is not subjected to a great thrust load, the shaft 5 only requires relatively compact tapered roller bearings 17 and 19 for support thereof. Therefore, as compared with prior arts, the shaft 5 and accompanying elements do not require unitized bearings and bolts for fixing thereof and hence can be formed more compactly. Moreover, the shaft 5 and the shaft 7 are capable of transmitting driving force to each other not by a chain transmission mechanism but by the reduction gear set 9 and further, since the reduction gear set 9 can be disposed between the bearings 17 and 19, they can be further formed in a compact constitution. Furthermore, length in the longitudinal direction correspondent to the direction where the vehicle moves can be shortened to a great extent. Because a count of parts is small and the constitution is simple, the weight thereof and the production cost can be reduced.

Of course, instead of the reduction gear set 9, a speed-up gear set, a chain transmission mechanism or a belt transmission mechanism may be applied.

Because the bearing 13 is disposed in the vicinity of the bevel gear 21 which inputs the driving force to the shaft 5, oscillation and vibration of the shaft 5 is reduced to a great extent and hence high durability can be obtained. Furthermore, such a constitution contributes increase in torque transmission efficiency of the change-direction gear set 55.

Moreover, because the support structure 1 uses the change-direction gear set 55 of the bevel gear type as an input/output device of the driving force, the support structure 1 can be readily applied to the transfer case 3 which is laterally disposed and transmits the driving force in the longitudinal direction.

Moreover, a hypoid gear may be applied to the change-direction gear set 55. In this case, a gear ratio (a speed-up ratio) can be made greater. The gears may be disposed in an offset arrangement and thereby freedom of design with respect to a floor position of the vehicle is increased to a great extent.

Moreover, because the helical gear 23 of the reduction gear set 9 abuts the inner races 27 and 29 of the bearings 13 and 15 and the helical gear 25 abuts the inner races 31 and 33 of the bearings 17 and 19, both pressurizing of the bearings 13, 15, 17 and 19 and centering of the shafts 5 and 7 are accomplished without any particular pressurizing device such as nuts. Because the pressurizing device is unnecessary to be provided, the structure thereof is made simple. Thereby reduction in the weight and the production cost can be conducted.

The hollow shaft 59 with the bearing 61 is installed in the casing main body 35 and, after installing the bearing 63, the right cover 39 is fixed, then installation of these members is finished. The shaft 5 with the bearing 13 is installed in the extending wall portion 50 and, after installing the bearing 15 to the shaft 5 and installing the bearing 19 to the shaft 7, the rear cover 43 is fixed, then assembly of the support structure 1 is finished. More specifically, because the support structure 1 is as described above, assembly and disassembly thereof are easy. Moreover it is possible to install these members without adding any particular pressurizing device for the bearings 13, 15, 17 and 19, instead select washers having proper thickness and install them therewith for example.

Moreover, the wall portion 49 partitioning the housing chamber 45 and the housing chamber 47 sufficiently increases strength of the casing main body 35 between the housing chamber 45 and the housing chamber 47 and hence prevents deformation of the casing 11 so as to stabilize the support structure 1. Therefore, operation durability of the transfer case 3 is improved.

### SECOND EMBODIMENT

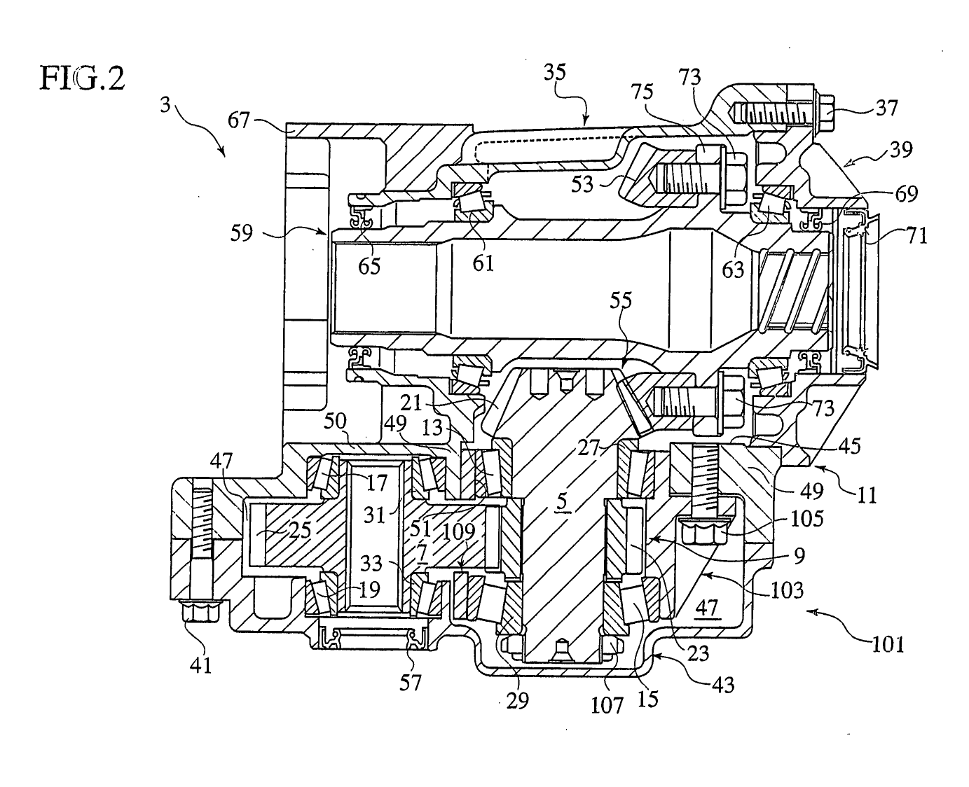

A second embodiment of the present invention will be described hereinafter with reference to FIG. 2. In the following description, substantially the same elements as the aforementioned elements will be referenced with the same numerals and the detailed descriptions thereof will be omitted. The description will be given to differences mainly.

In accordance with the second embodiment, instead of the aforementioned support structure 1, a support structure 101 shown in FIG. 2 is provided. In the support structure 101, a cylindrical member 103 is housed in the wall portion 49 of the first housing chamber 47 and fixed with the casing main body 35 by means of bolts 105. The shaft 5 is rotatably supported by the cylindrical member 103 by means of the tapered roller bearings 13 and 15 and composes a sub-assembly.

A nut 107 is screwed on a rear end of the shaft 5 and presses the inner race 29, the helical gear 23 and the inner race 27 so as to pressurize and center the bearings 13 and 15.

Moreover, the cylindrical member 103 is provided with an opening 109 linking with the opening 51 of the wall portion 49. The helical gear 25 of the reduction gear set 9 is disposed in the housing chamber 47 and passes through the opening 109 to engage with the helical gear 23.

Before the rear cover 43 is installed to the casing main body 35, the sub-assembly composed of the cylindrical member 103 and the shaft 5 can be installed to the casing main body 35 by fixing the cylindrical member 103 with the casing main body 35 with the bolts 105. Then, by engaging the bevel gear 21 of the shaft 5 with the bevel gear 53, the change-direction gear set 55 is formed.

In accordance with the present embodiment, since the cylindrical member 103 and the shaft 5 are formed to be a sub-assembly, installation thereof comes to be prominently easy. Moreover, similarly to the case of the above first embodiment, unitized bearings are not required and hence the structure comes to be more simple and compact. Furthermore, it is advantageous in reduction in the weight and the production cost.

Moreover, similarly to what aforementioned, various power transmission devices can be applied instead of the reduction gear set 9.

Because the bearing 13 is disposed in the vicinity of the bevel gear 21, oscillation and vibration of the shaft 5 is reduced to a great extent and hence high durability can be obtained. Furthermore, such a constitution contributes increase in torque transmission efficiency of the change-direction gear set 55.

Moreover, because the support structure 101 uses the change-direction gear set 55 of the bevel gear type as an input/output device of the driving force, the support structure 101 can be readily applied to the transfer case 3 which is laterally disposed and transmits the driving force in the longitudinal direction.

Moreover, a hypoid gear can be applied to the change-direction gear set 55. In this case, a gear ratio (a speed-up ratio) can be made greater. The gears can be disposed in an offset arrangement and thereby freedom of design with respect to a floor position of the vehicle is increased to a great extent.

Moreover, because the helical gear 23 of the reduction gear set 9 abuts the inner races 27 and 29 of the bearings 13 and 15 and the helical gear 25 abuts the inner races 31 and 33 of the bearings 17 and 19, both pressurizing of the bearings 13, 15, 17 and 19 and centering of the shafts 5 and 7 are accomplished without any particular pressurizing device such as nuts. Because the pressurizing device is unnecessary to be provided, the structure thereof is made simple and reduction in the weight and the production cost can be conducted.

The hollow shaft 59 with the bearing 61 is installed in the casing main body 35 and, after installing the bearing 63, the right cover 39 is fixed, then installation of these members is finished. The shaft 5 with the bearings 13 and 15 is installed on the wall portion 49 of the casing main body 35 via the cylindrical member 103 with the bolts 105; the shaft 7 with the bearing 17 is installed in the extending wall portion 50; and, after installing the bearing 15 to the shaft 5 and installing the bearing 19 to the shaft 7, the rear cover 43 is fixed, then assembly of the support structure 101 is finished. More specifically, because the support structure 101 is as described above, assembly and disassembly thereof are easy. Moreover it is possible to install these members by pressurizing the bearings 13 and 15 with tightening force of the nut 107 and selecting and disposing washers having proper thickness on any one of the bearings 17 and 19.

Moreover, similarly to the aforementioned first embodiment, the wall portion 49 partitioning the housing chamber 45 and the housing chamber 47 sufficiently increases strength of the casing main body 35 and stabilizes the support structure 101. Therefore, operation durability of the transfer case 3 is improved.

### THIRD EMBODIMENT

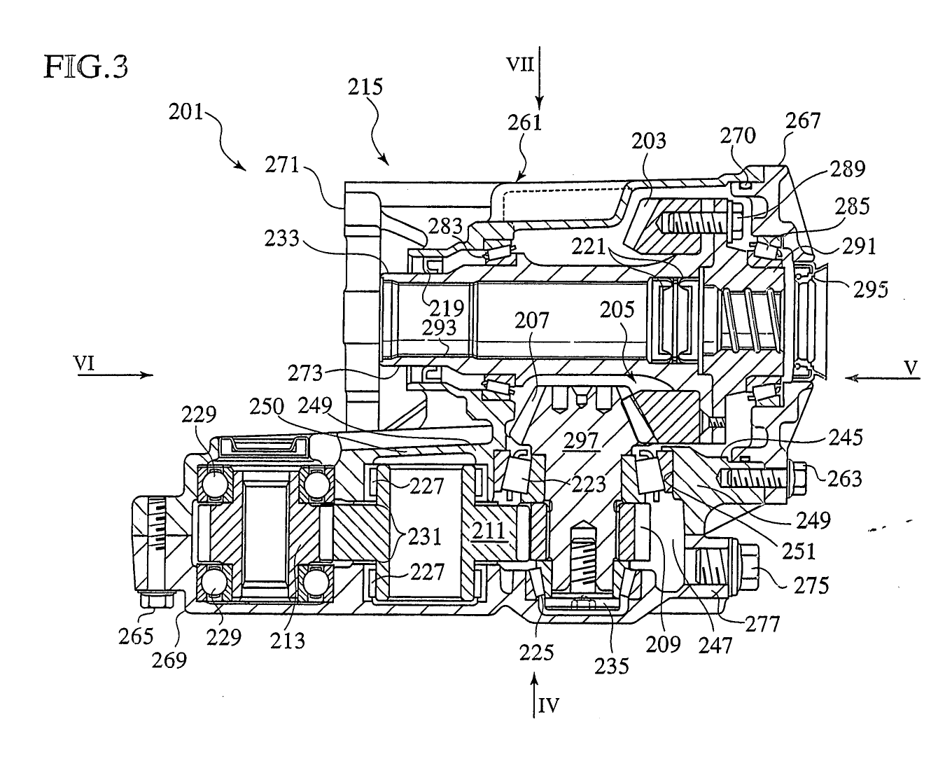

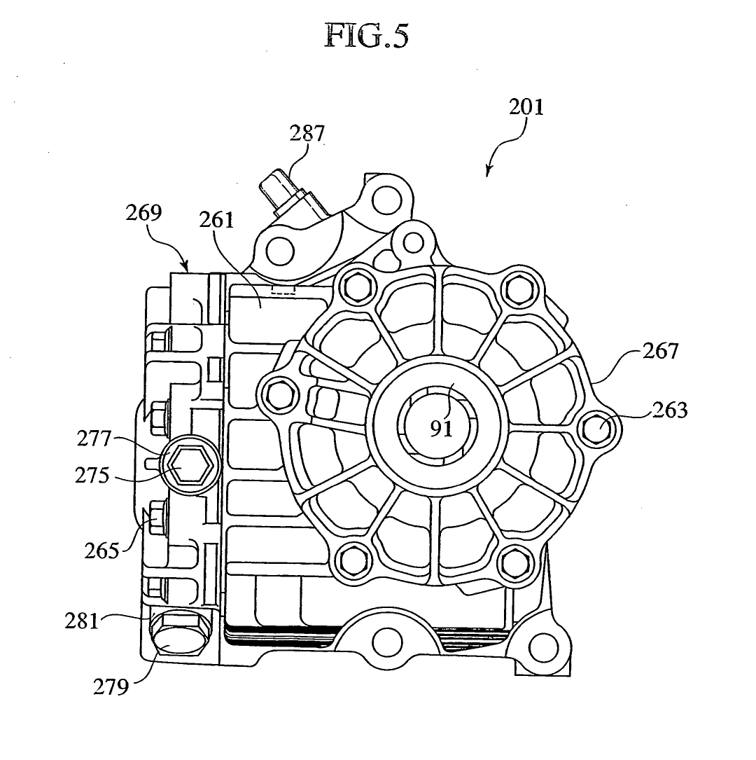

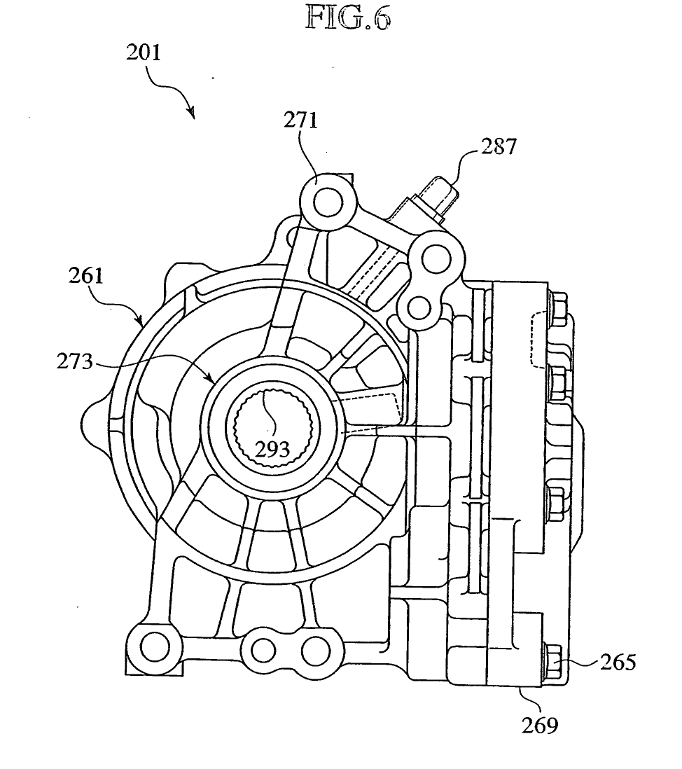

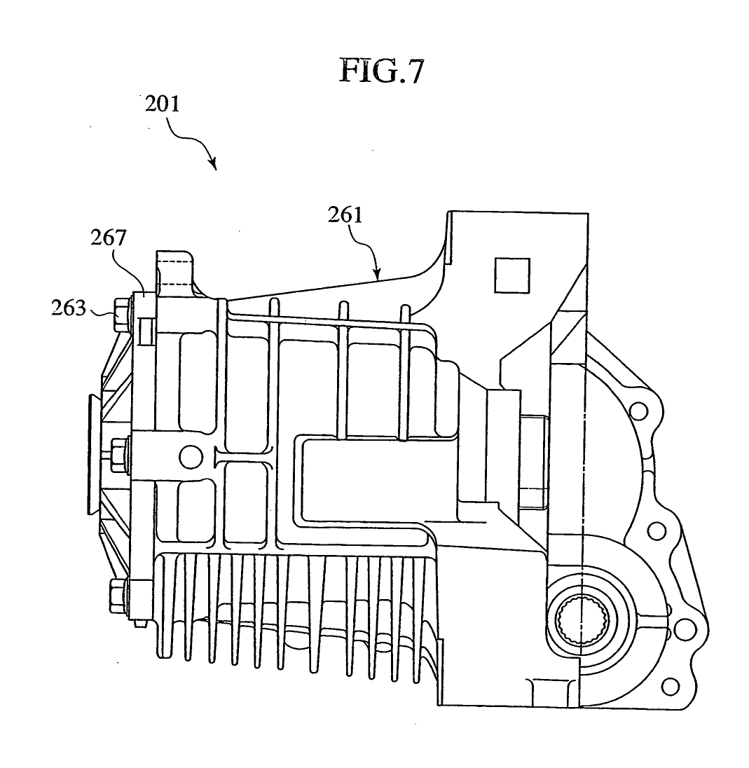

A third embodiment of the present invention will be described hereinafter with reference to FIGS. 3 through 7.

A transfer case 201 is provided with a bevel gear 203 (one of change-direction gears), a bevel gear 207 (another of the change-direction gear) engaging with the bevel gear 203 to form a change-direction gear set 205, a helical gear 209 (a first gear) coaxially and integrally rotating with the bevel gear 207, a hollow helical gear 211 (a second gear) disposed in parallel with and engaged with the helical gear 209, a hollow helical gear 213 (a third gear) disposed in parallel with and engaged with the helical gear 211, and a casing 215 for housing the change-direction gear set 205 and the respective helical gears 209, 211 and 213. The transfer case 201 is configured so that driving force from a transmission 317 (FIG. 8) is input into the bevel gear 203 and output from the helical gear 213. Moreover, seals 219 and 221 for preventing mixing transfer oil with transmission oil of the transmission 317. The helical gear 209 is disposed between a pair of tapered roller bearings 223 and 225 (roller bearings: a pair of bearings receiving forces in an axial direction and a radial direction) and rotatably supported thereby. The helical gear 211 is disposed between a pair of needle bearings 227 (roller bearings using needle-like rolling bodies) and rotatably supported thereby. The helical gear 213 is disposed between and rotatably supported by a pair of ball bearings 229. The helical gear 209 is smaller in diameter than the bearing 223 and the helical gear 213 is smaller in diameter than the respective ball bearings 229. To avoid interference between a propeller shaft 331 (a third power transmission shaft linked with a gear: FIG. 8) coupled with the helical gear 213 and a hollow input shaft 233 coupled with the bevel gear 203, an angle between a rotation axis C2 of the helical gear 209 and a rotation axis C4 of the helical gear 213 with respect to a rotation axis C3 of the helical gear 211 is set to be θ; and the respective helical gears 209, 211 and 213 are respectively disposed offset in a perpendicular direction; as well as the helical gear 213 is given an offset OS4 required to avoid interference between the propeller shaft 331 coupled with the helical gear 213 and the input shaft 233 coupled with the bevel gear 203. The bearings 223 and 225 are paired bearings supporting the bevel gear 207 and the helical gear 209 is disposed therebetween. The bevel gear 207 composing the change-direction gear set 205 is provided with a bolt 235 (a regulation device) to regulate tooth contact and pressure against the bevel gear 203 (the opposite gear) by changing the axial position thereof. Further, washers 237 (positioning devices) are provided for axially positioning the needle bearings 227 of the helical gear 211.

The casing 215 is, as shown in FIG. 3, composed of a casing main body 261 and case covers 267 and 269 respectively fixed on the right side face and the left side face of the casing main body 261 by six bolts 263 and twelve bolts 265. An O-ring 270 is disposed between the casing main body 261 and the case cover 267 for preventing oil leakage. The casing 215 is installed on the transmission 317 by means of abutment by an abutment surface 271 provided on the casing main body 261 and fitting by a fitting surface 273 and a plurality of cooling ribs are formed on an outer periphery thereof. Moreover, the casing main body 261 is provided with a wall portion 249 and an extending wall portion 250 extending leftward in FIG. 3. A shaft 297 described later penetrates an opening 251 which the wall portion 249 has.

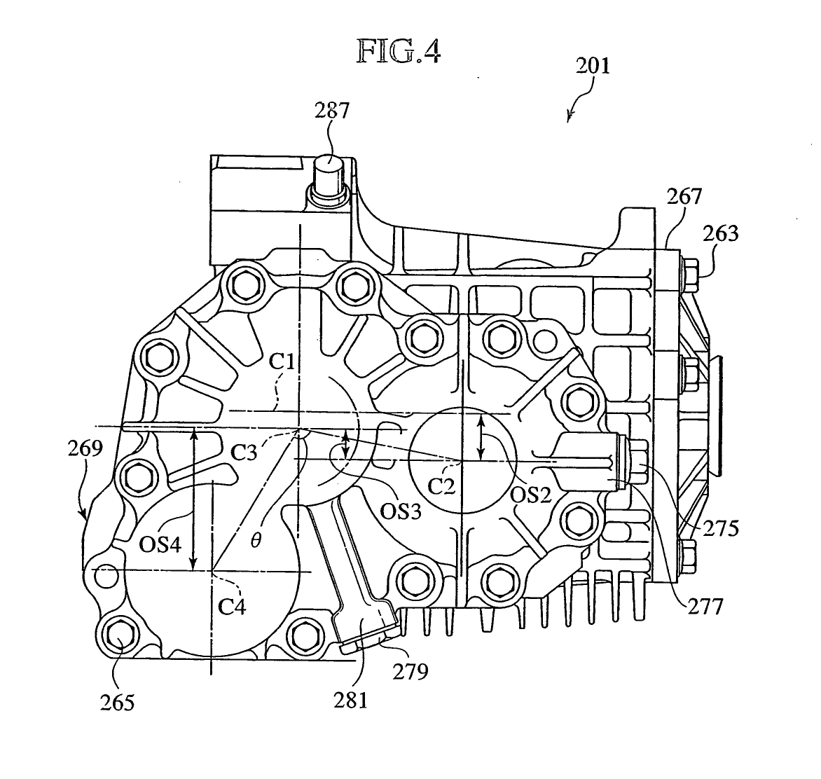

As shown in FIGS. 4, 5 and 6, the casing 215 (a case cover 269) is provided with an oil filler 277, to which a filler plug 275 is fitted, and an oil drain 281, to which a filler plug 279. The transfer oil is filled into the interior of the casing 215 via the oil filler 277 and draining of the oil is achieved through the oil drain 281. As shown in FIG. 4, the oil filler 277 is disposed above in the perpendicular direction with respect to lower portions of undermentioned bearings 283 and 285 supporting the bevel gear 203 and the input shaft 233 and bearings 223 and 225 supporting the bevel gear 207 and the helical gear 209 respectively so as to improve lubrication thereof. The oil drain 281 is disposed in a range of the angle θ formed by the respective helical gears 209, 211 and 213 so as to make the transfer case 201 compact.

Moreover, an air breather 287 is provided perpendicularly above the casing 215 (the casing main body 261) and minimizes pressure difference between the interior and the exterior to prevent blowout of the transfer oil and intrusion of alien substances.

The bevel gear 203 is co-tightened by bolts 291 with the input shaft 233 and a hollow hub. The input shaft 233 is supported by the casing main body 261 by means of the tapered roller bearing 283 and the hub 291 is supported by the case cover 267 by means of the tapered roller bearing 285. The bevel gear 203, the input shaft 233 and the hollow hub 291, which are coaxially coupled with each other, are disposed in the lateral direction with respect to the vehicle. The input shaft 233 is coupled with a differential case side of the rear differential 341 and the axle 345 penetrates the input shaft 233 and the hollow hub 291 and links between the rear differential 341 and the right rear axle 349.

The seal 219 is disposed between the input shaft 233 and the casing main body 215 and the plural seals 221 are disposed between the input shaft 233 and the axle 345 so that mixing of the transfer oil and the transmission oil is prevented. Moreover a seal 295 is disposed between the axle 345 and the case cover 267 so that leakage of oil and intrusion of alien substances are prevented.

The bevel gear 207 is integrally formed at a front end side of the drive pinion shaft 297 disposed in the longitudinal direction with respect to the vehicle and changes the rotation of the bevel gear 203 composing the change-direction gear set 205 in a right angle direction so as to transmit the rotation to the drive pinion shaft 297.

The bolt 235 is screwed in the rear end of the bevel gear 207. When rotating the bolt 235, the bevel gear 207 (the drive pinion shaft 297) is moved in the axial direction so that the tooth contact and the pressure with respect to the bevel gear 203 can be regulated. Meanwhile, as such regulation devices for the tooth contact and the pressure, as well as the bolts, a washer or a shim may be exemplified, thickness of which may be selected and which changes the axial positions of the bevel gear 203 and 207.

The helical gear 209 is splined to couple with the drive pinion shaft 297 between the bearings 223 and 225 and is moreover smaller in diameter than the bearing 223.

The helical gear 211 is integrally formed with the hollow shaft 299 between the pair of needle bearings 227, one of which is supported by the casing main body 261 and another of which is supported by the case cover 269. Interference between the bearings 223 and 225 of the helical gear 209 and the ball bearing 229 of the helical gear 213 is prevented because the needle bearings 227 having small diameters are applied. As much as the diameters are minimized, the transfer case 201 is formed more compact.

Moreover, as shown in FIG. 3, the respective washers 237 positions the needle bearings 227 in the axial direction so as to regulate engagement of the helical gears 209 and 213 with respect to the helical gear 211 in a normal state. Meanwhile, the washers 237 may be formed in a unitary body with, for example, outer races of the needle bearings 227.

The helical gear 213 is integrally formed with the hollow shaft 101 between the pair of needle bearings 229, one of which is supported by the casing main body 261 and another of which is supported by the case cover 269. Moreover, the helical gear 213 is coupled with the propeller shaft 331 via the power transmission shaft coupled with the spline portion 103; and a seal 105 is disposed between the power transmission shaft and the casing main body 215 so as to prevent oil leakage and alien substance intrusion.

As shown in FIG. 4, an offset OS2 in a downward direction is given to the rotation axis C2 of the helical gear 209 with respect to the rotation axis C1 of the bevel gear 203 and the input shaft 233; an offset OS3 in an upward direction is given to the rotation axis C3 of the helical gear 211 with respect to the rotation axis C2; and an offset OS4 in a downward direction is given to the rotation axis C4 of the helical gear 213 with respect to the rotation axis C3. The offset OS4 is given a value required to prevent interference between the aforementioned power transmission shaft at the side of the helical gear 213 and the input shaft 233 at the side of the propeller shaft 331 and the bevel gear 203.

As mentioned above, the driving force transmitted from the engine to the transfer case 201 via the transmission 317 (the differential case of the rear differential 341) is transmitted from the input shaft 233 to the change-direction gear set 205. Thereby the direction of the driving force is changed and transmitted to the propeller shaft 331 via the helical gears 209, 211 and 213.

Because the gear transmission mechanism composed of the gears 209, 211 and 213 is applied to the transfer case 201, in contrast with prior arts to which chain transmission mechanisms are applied, the transfer case 201 is formed compactly with respect to lengths both in the longitudinal direction and in the lateral direction relative to the direction where the vehicle moves. Therefore the transfer case 201 may be disposed in a small space. Freedom of the layout is increased and hence the transfer case 201 may be loaded in various vehicles.

Moreover, because the gear transmission mechanism is composed of three gears 209, 211 and 213 and hence the drive force is transmitted without changing the rotation direction, the rear differential 341 is not required to be changed in the rotation direction to the opposite direction. Cost increase accompanying such a change can be avoided.

Moreover, intermixing of the transmission oil and the transfer oil is prevented by means of the seals 219 and 221 so that the functions of the transmission and the transfer case are kept in normal states.

Moreover, the transfer case 201 is made to be a sub-assembly (to be unitized) since the aforementioned seals 219 and 221 are provided. Therefore a four-wheel drive vehicle can be readily formed only by installing the transfer case 201 made to be the sub-assembly, and the propeller shaft 331, the coupling 353 and the front differential 351 as a power transmission system, in a R-R vehicle of a basic constitution. As well, the R-R vehicle can be commonly used for construction of a two-wheel drive vehicle and a four-wheel drive vehicle and hence both the two-wheel drive vehicle and the four-wheel drive vehicle can be established at low costs.

Moreover, the helical gear 209 is supported between the paired bearings 223 and 225, the helical gear 211 is supported between the paired bearings 227 and the helical gear 213 is supported between the paired bearings 229, thereby waste of a disposition space is avoided. The constitution is made more compactly and installation in vehicles is made easier as much as avoiding the waste.

Moreover, the helical gear 209 is smaller in diameter than the bearing 223 and the helical gear 213 is smaller in diameter than any of the ball bearings 229, thereby the constitution is made more compactly and installation in vehicles is made easier in the radial direction as much as the gears are smaller in the diameters.

Moreover, the helical gear 209 and the helical gear 213 are disposed so as to form the predetermined angle θ therebetween with respect to the helical gear 211 as a center of the angle, thereby the whole constitution is made compactly and installation in vehicles is made easier.

Moreover, the respective helical gears 209, 211 and 213 are respectively disposed offset with respect to the bevel gear 203, thereby the constitution is made compactly to a great extent and installation in vehicles is made easier.

Furthermore, because of the aforementioned constitution, interference between a propeller shaft 331 coupled with the helical gear 213 and the input shaft 233 coupled with the bevel gear 203 is avoided and further because of disposition of the propeller shaft 331 interposing the input shaft 233 in the vertical direction, the constitution can be made more compactly to a great extent and installation in vehicles can be made easier.

Moreover, the reaction force generated at the bevel gear 207 is born by the bearings 223 and 225, which bear forces in axial directions, thereby the change-direction gear set 205 is kept in a normal state and the durability thereof is improved.

Moreover, because the helical gear 209 is supported between the bearings 223 and 225 for the bevel gear 207, the bevel gear 207 and the helical gear 209 are disposed along a common axis (the drive pinion shaft 297), thereby waste of a disposition space is avoided. The constitution is made more compactly and installation in vehicles is made easier as much as avoiding the waste.

Moreover, tooth contact and pressure of the change-direction gear set 205 are preferably regulated, thereby the normal operation is preserved and the durability is improved.

Moreover, because the needle bearings 227 having small diameters are applied to bearings for supporting the helical gear 211 disposed between the helical gear 209 and the helical gear 213, interference between the bearings 223 and 225 supporting the gear 209 and the ball bearings 229 supporting the gear 11 as well as the transfer case 201 is formed in a compact constitution in the axial direction (the lateral direction with respect to the vehicle) of the respective gears 209, 211 and 213 and installation in vehicles is made easier as much as miniaturizing of the bearings.

Moreover, because the needle bearings 227 supporting the helical gear 211 are positioned in the axial direction by means of the washers 237 as a positioning regulation device, engagement of the helical gears 209 and 213 with respect to the helical gear 211 in a normal state and hence durability is improved.

Moreover, because helical gears are applied to the respective gears 209, 211 and 213 and generally have high contact gear ratios, the transfer case 201 gains a great torque transmission capacity as much as the contact gear ratio thereof is increased as well as noise is reduced and hence quality of silence is improved.

Moreover, because of having the wall portion 249, the casing main body 261 gains a sufficient strength and prevents deformation of the casing 261 to stabilize the support structure 1.

The input shaft 233 with the seal 219 and the bearing 283 is installed in the casing main body 261 and, after installing the bearing 285, the case cover 267 is fixed, then installation of these members is finished. The shaft 297 with the gear 209 and the bearing 223, the gear 211 with one of the bearings 227 and the gear 213 with one of the bearings 229 are respectively installed in the casing main body 261 and, after installing others of the bearings 225, 227 and 229 in the respective shafts, the case cover 269 is fixed, then installation of these members is finished. More specifically, because the support structure is as described above, assembly and disassembly thereof are easy. Meanwhile, as described in detail, the bearing 223 is housed in and supported by the wall portion 249 of the casing main body 261 and one of the bearings 227 and one of the bearings 229 are housed in and supported by the extending wall portion 250.

The transfer case in accordance with any of the aforementioned embodiments may be applied to a midship four-wheel drive vehicle based on rear-wheel drive as shown in FIG. 8. In FIG. 8, the transfer case is referred to a reference numeral 301. The four-wheel drive vehicle is based on a midship R-R (rear-engine and rear-drive) vehicle using an engine 339 as a power source and provided with the engine 339, a transmission 317, a rear differential 341 built in the transmission 317, a transfer case 201, rear axles 343 and 345, left and right rear wheels 347 and 349, a front differential 351, a coupling 353 disposed between a propeller shaft 331 and the front differential 351, front axles 355 and 357, left and right front wheels 359 and 361 and such.

The engine 339 is transversely disposed in a front portion of the vehicle (at the rear of the front axles 355 and 357). The driving force thereof is transmitted to the rear differential 341 with changing speed by means of the transmission 317 and distributed via the rear axles 343 and 345 to the left and right rear wheels 347 and 349. Moreover, if the coupling 353 is linked therewith, the driving force of the engine 339 is transmitted via the transfer case 201, the propeller shaft 331 and the coupling 353 to the front differential 351 and distributed via the front axles 355 and 357 to the left and right front wheels 359 and 361, then the vehicle comes into a four-wheel drive mode.

Moreover, if the link of the coupling 353 is cancelled, the front differential 351, the front axles 355 and 357 and the left and right front wheels 359 and 361 are separated therefrom and hence the vehicle comes into a two-wheel drive mode of rear-wheel drive.

The transfer case in accordance with any of the aforementioned embodiments can be applied to a midship four-wheel drive vehicle based on front-wheel drive as shown in FIG. 9. In FIG. 9, the transfer case is referred to a reference numeral 301. The four-wheel drive vehicle is based on a midship F-F (front-engine and front-drive) vehicle using an engine 339 as a power source and provided with the engine 339, a transmission 317, a front differential 351 built in the transmission 317, a transfer case 201, front axles 355 and 357, left and right front wheels 359 and 361, a rear differential 341, a coupling 353 disposed between a propeller shaft 331 and the rear differential 341, rear axles 343 and 345, left and right rear wheels 347 and 349 and such.

The engine 339 is transversely disposed in a front portion of the vehicle (at the rear of the front axles 355 and 357). The driving force thereof is transmitted to the front differential 351 with changing speed by means of the transmission 317 and distributed via the front axles 355 and 357 to the left and right front wheels 359 and 361. Moreover, if the coupling 353 is linked therewith, the driving force of the engine 339 is transmitted via the transfer case 201, the propeller shaft 331 and the coupling 353 to the rear differential 341 and distributed via the rear axles 343 and 345 to the left and right wheels 347 and 349, then the vehicle comes into a four-wheel drive mode. Moreover, if the link of the coupling 353 is cancelled, the rear differential 341, the rear axles 343 and 345 and the left and right wheels 347 and 349 are separated therefrom and hence the vehicle comes into a two-wheel drive mode of front-wheel drive.

Meanwhile, as mentioned above, not only the bolts but also a washer or a shim, which changes the axial positions of the respective gears of the change-direction gear set, may be applied to the regulation device for the tooth contact and the pressure of the change-direction gear set.

Moreover, in the transfer case according to the third embodiment, the constitution may be modified to input the driving force from the third gear and output the power from one of the change-direction gear set.

Moreover, the third embodiment of the present invention may be applied to not only the transfer case but also any gear mechanisms which require a change-direction function with respect to the driving force (rotation) and a normal-rotation transmission function for the driving force by a triple gear.

Moreover, sliding bearings (metal bearings) may be applied to the bearing supporting the second gear. In this case, the effect of prevention of the interference with respect to the bearings of the first gear and the third gear and the effect of miniaturization are further improved.

Moreover, for application of the bearing structure in any of the embodiments of the present invention, any bearings may be selected and applied from the group of rolling-contact bearings such as ball bearings, angular-contact ball bearings, cylindrical roller bearings, conical roller bearings and such; single rows of these bearings; double rows of these bearings; and any combinations thereof. Further, if necessary, sliding bearings and such may be applied thereto. These bearings contribute to cost reduction as similar to the aforementioned description.

Moreover, application of the support structures of the present invention may be not limited to a part of the transfer case as mentioned above and may be applied to any version in which a power transmission device gives and receives driving force through an input shaft and an output shaft.

Moreover, a gear set, a chain transmission mechanism, a belt transmission mechanism and any other transmission mechanism may be applied to the power transmission device. Further, these power transmission devices maybe applied to either speed-up or reduction gear mechanism.

### INDUSTRIAL APPLICABILITY

A transfer case which is compactly constituted, includes reduced number of parts, reduces oscillation and vibration of shafts and has high durability is provided.

1. A support structure comprising:
an input shaft and an output shaft for input and output of driving force;
a power transmission device coupling the input shaft with the output shaft;
a housing member housing the input shaft, the output shaft and the power transmission device;
a pair of first bearings aligned in an axial direction, the first bearings rotatably supporting the input shaft with respect to the housing member; and
a pair of second bearings aligned in an axial direction, the second bearings rotatably supporting the output shaft with respect to the housing member,
wherein the power transmission device is disposed between the pair of the first bearings, and
at least any one pair of the first bearings and the second bearings are disposed in the vicinity of an input/output device for input/output the driving force to the input shaft and the output shaft.

2. The support structure of claim 1, wherein:
the input/output device is a change-direction transmission device.

3. The support structure of claim 1, wherein:
the power transmission device is disposed so as to respectively abut shaft side members of the pair of the second bearings.

4. The support structure of claim 1, wherein:
the housing member comprises a wall portion, and
the first bearings are rotatably supported by the wall portion.

5. The support structure of claim 4, wherein:
the wall portion further comprises an opening, and
the input shaft penetrates the opening so as to be coupled with the output shaft.

6. A gear mechanism:
a change-direction gear set to change a rotation direction of a driving force at a right angle, the change-direction gear set comprising a first change-direction gear and a second change-direction gear;
an input shaft rotating coaxially and integrally with the second change-direction gear;
an output shaft disposed in parallel with the input shaft;
a power transmission device coupling the input shaft with the output shaft;
a housing member housing the input shaft, the output shaft and the power transmission device;
a pair of first bearings aligned in an axial direction, the first bearings rotatably supporting the input shaft with respect to the housing member;
a pair of second bearings aligned in an axial direction, the second bearings rotatably supporting the output shaft with respect to the housing member; and
a pair of third bearings rotatably supporting the first change-direction gear with respect to the housing member, wherein the power transmission device is disposed between the pair of the first bearings, and
at least any one pair of the first bearings and the second bearings are disposed in the vicinity of the second change-direction gear.

7. The gear mechanism of claim 6, wherein:
the housing member comprises a first housing member, a second housing member and a third housing member,
one of the pair of the first bearings, one of the pair of the second bearings and one of the pair of the third bearings are housed in the first housing member,
another of the pair of the first bearings and another of the pair of the second bearings are housed in the second housing member, and
another of the pair of the third bearings is housed in the third housing member.

8. A gear mechanism comprising:
a change-direction gear set to change a rotation direction of a driving force at a right angle, the change-direction gear set comprising a first change-direction gear and a second change-direction gear;
a first gear rotating coaxially and integrally with the second change-direction gear;
a second gear disposed in parallel with and engaged with the first gear;
a third gear disposed in parallel with and engaged with the second gear; and
a casing housing the change-direction gear set, the first gear, the second gear and the third gear.

9. The gear mechanism of claim 8,
wherein the first change-direction gear coupled with an output of a transmission of a vehicle to transmit the output to the third gear, and
further comprising a seal to prevent intrusion of oil in the transmission.

10. The gear mechanism of claim 8, further comprising:
a pair of bearings,
wherein at least any one of the first gear, the second gear and the third gear is disposed between the pair of the bearings.

11. The gear mechanism of claim 10, wherein:
at least any one of the first gear, the second gear and the third gear is smaller in diameter than the bearings.

12. The gear mechanism of claim 8, wherein:
a plane formed by a rotation axis of the first gear and a rotation axis of the second gear and another plane formed by the rotation axis of the second gear and a rotation axis of the third gear form an angle smaller than 180 degrees and the rotation axis of the third gear is disposed in a direction away from the rotation axis of the first change-direction gear.

13. The gear mechanism of claim 8, wherein:
the second gear and the third gear are disposed offset in respective perpendicular directions relative to the a rotation axis of a power transmission member coupled with the first change-direction gear,
a rotation axis of the first gear is disposed offset in a direction away from the first change-direction gear,
a rotation axis of the second gear is disposed offset in a direction closer to the first change-direction gear than the rotation axis of the first gear, and
a rotation axis of the third gear is disposed offset in a direction more distant from the first change-direction gear than the second gear.

14. The gear mechanism of claim 8, wherein:
at least any one of the first change-direction gear and the second change-direction gear is rotatably supported by a pair of bearings receiving force in an axial direction.

15. The gear mechanism of claim 8, wherein:
the first gear is disposed between a pair of bearings rotatably supporting the second change-direction gear and rotatably supported.

16. The gear mechanism of claim 8, wherein:
at least any one of the first change-direction gear and the second change-direction gear comprises a regulation device for regulating tooth contact and pressure of the change-direction gear set by changing an axial direction.

17. The gear mechanism of claim 8, wherein:
a pair of bearings supporting the second gear are roller bearings having cylindrical or needle-like rolling bodies.

18. The gear mechanism of claim 17, further comprising:
a positioning device configured to position the roller bearings in an axial direction.

19. The gear mechanism of claim 8, wherein:
any of the first gear, the second gear and the third gear are helical gears.
